(19) United States
(12) Patent Application Publication
(10) Pub. No.: US 2022/0091810 A1
(43) Pub. Date: Mar. 24, 2022

(54) MODIFYING AN INTERFACE DISPLAYING VIDEO CONTENT RECEIVED FROM USERS PARTICIPATING IN A VIDEO EXCHANGE SESSION BASED ON INPUT FROM A PARTICIPATING USER

(71) Applicant: Meta Platforms, Inc., Menlo Park, CA (US)

(72) Inventor: Kathleen Warner, Napa, CA (US)

(21) Appl. No.: 17/540,187

(22) Filed: Dec. 1, 2021

Related U.S. Application Data
(60) Provisional application No. 63/123,922, filed on Dec. 10, 2020.

(51) Int. Cl. G06F 3/14; H04N 5/272; G06F 3/04842; G06F 3/04845; H04L 65/403; H04L 67/141

(52) U.S. Cl. CPC G06F 3/1454; H04N 5/272; G06F 3/04842; G06F 2203/04803; H04L 65/403; H04L 67/141; G06F 3/04845

(57) ABSTRACT

When an online system creates a video exchange session, an interface including regions displaying video content from users participating in the video exchange session is generated and displayed to the users. The online system may modify the interface generated for displaying video content received from users participating in a video exchange session based on inputs received from a user participating in the video exchange session. The interface may display a topic for discussion by users in a region in response to an input from the user. Alternatively, the online system overlays content on video content received from a specific user providing input. In another embodiment, the online system displays a notification to users via the interface when a user requests capture of an image of the interface.

### CROSS-REFERENCE TO RELATED APPLICATIONS

This application claims the benefit of U.S. Provisional Application No. 63/123,922, filed Dec. 10, 2020, which is incorporated by reference in its entirety.

### BACKGROUND

This disclosure relates generally to exchange of video content between users of an online system.

Users of online systems increasingly communicate by exchanging video content captured by their respective client devices. For example, a user of an online system establishes a video exchange session with one or more other users of the online system. During the video exchange session, the online system displays an interface to users participating in the video exchange session. The interface displayed to a user displays video content received from other users participating in the video exchange session in different portions of the interface, allowing a user viewing the interface to see video content from client devices of other users. For example, the interface displays video content captured by client devices of users participating in the video exchange session, allowing users participating in the video exchange session to synchronously exchange video content captured by their respective client devices.

Conventional online systems allow a user to request establishment of a video exchange session by providing an invitation to join the video exchange session to other users invited to participate in the video exchange session. By accepting the invitations, the other users exchange video content with the requesting user through the video exchange session. While video exchange sessions established by conventional online systems allow users to exchange video data, interfaces for exchanging video data provide limited additional content to users. For example, a conventional video exchange interface displays video content received from different users but does not display additional content to provide relief or distraction from the exchanged video content. This lack of content other than the shared video content may reduce a frequency with which users exchange video data through an online system.

### SUMMARY

An online system receives a creation request from a requesting user for a video exchange session to exchange video content where the requesting users and one or more other users exchange video content captured by their respective client devices. In various embodiments, the creation request identifies one or more other users to whom the online system transmits invitations to join the video exchange session. For example, the creation request includes user identifiers of specific users provided by the requesting user, so the online system transmits invitations to the specific users. As another example, the creation request includes a specific characteristic of users, so the online system transmits an invitation to join the video exchange session to users having the specific characteristic.

The online system transmits invitations to join the video exchange sessions to users identified by the creation request from the requesting user. In various embodiments, an invitation to join the video exchange session includes thematic information from the activity specified for the video exchange session. The invitation includes information identifying the video exchange session, and a link that, when accessed by a user via a client device, causes the client device of the user to join the video exchange session. For example, the requesting user specifies a name of the video exchange session in the creation request to the online system, and the invitation transmitted from the online system to one or more other users identified by the creation request includes the name of the video exchange session. The invitations transmitted from the online system to the one or more other users may include other information, such as a description of the video exchange session or information identifying the requesting user.

In response to receiving acceptances of invitations from one or more users, the online system establishes the video exchange session between the requesting user and the one or more users from whom acceptances of invitations were received. The online system generates the interface for the video exchange session associating each user participating in the video exchange with a region in the interface and allocating one or more regions in the interface as external regions in which external video is displayed. The online system transmits the generated interface to client devices of users participating in the video exchange session, with the client devices displaying the interface so video content from each user participating in the video exchange session is shown in a region corresponding to the user. In some embodiments, the interface displays video content received from a user to whom the interface is displayed in the interface, while in other embodiments, the interface does not display video content received from the user to whom the interface is displayed via the user's client device.

The online system may modify the interface generated for displaying video content received from users participating in a video exchange session based on inputs received from a user participating in the video exchange session. In one embodiment, the generated interface includes a prompt region that displays a prompt to users participating in the video exchange session. When a user participating in the video exchange session selects the prompt region, the content of the prompt region is modified to display a question or a statement to users participating in the video exchange session via the interface to encourage interactions between the users participating in the video exchange session. In other embodiments, the online system modifies video data received from a user participating in a video exchange session by overlaying images or text on video data corresponding to a specific input received from the user participating in the video exchange session and displays the modified video data to other users via a region associated with the user within the interface. Additionally, the online system may display a notification or countdown information to users participating in the video exchange session via the interface in response to receiving an input from a user participating in the video exchange session notifying users participating in the video exchange session that a user has requested to capture an image of the interface. After displaying the notification or countdown information, the online system captures an image of the interface.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIGS. 3A and 3B are example interfaces displayed to users who have joined a video exchange session, in accordance with an embodiment.

FIGS. 4A and 4B is an example interface displaying a prompt of a topic for users participating in a video exchange session to address, in accordance with an embodiment.

FIG. 5 is an example interface where a region of the interface displaying video content from a user displays a graphic indication in response to an input from the user, in accordance with an embodiment.

FIG. 6 is an example interface displaying a countdown to users participating in a video exchange session for a screen capture of the video exchange session, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

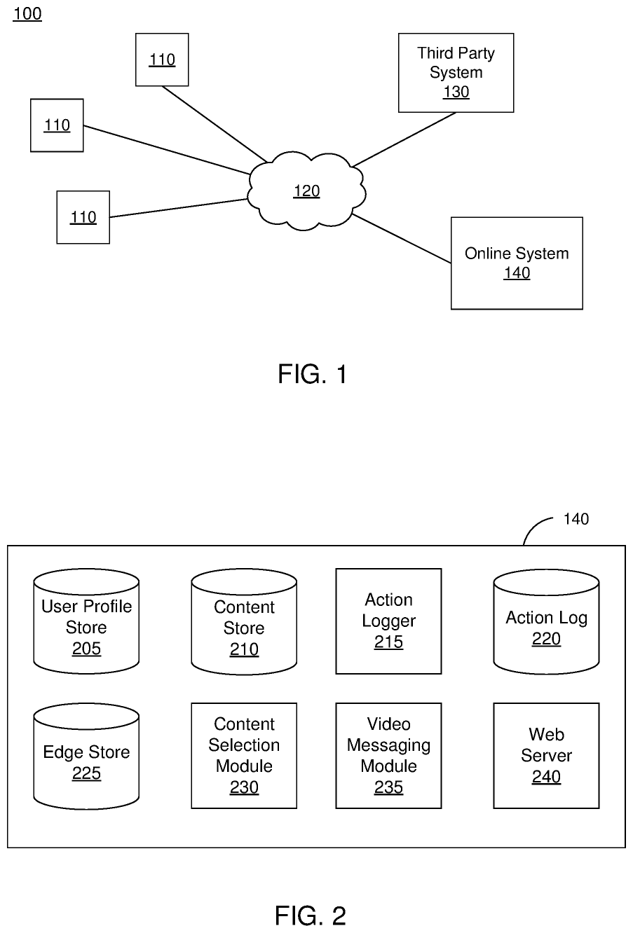

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a content selection module 230, a video messaging module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with content items when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the content item's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items, such as stories describing actions associated with other online system users connected to the user, which are not associated with bid amounts. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

The video messaging module 235 allows users of the online system 140 to exchange video content captured by client devices 110 corresponding to each of the users. In various embodiments, the video messaging module 235 receives a creation request from a requesting user for a video exchange session to exchange video content with other users that identifies one or more other users. The video messaging module 235 transmits an invitation to join a video exchange session to the identified one or more other users. The invitation includes information identifying the video exchange session, and a link that, when accessed by a user via a client device 110, causes the client device 110 of the user to join the video exchange session. For example, the requesting user specifies a name of the video exchange session in the creation request to the video messaging module 235, and the invitation transmitted from the video messaging module 235 to one or more other users identified by the creation request includes the name of the video exchange session. The invitation transmitted from the video messaging module 235 to the one or more other users may include other information, such as a description of the video exchange session or information identifying the requesting user.

In various embodiments, the requesting user specifies an activity for the video exchange session in the creation request. The activity identifies thematic content of the video exchange session. Example thematic content for the video exchange session include a name for the video exchange session, backgrounds from which video content received from a user participating in the video exchange session (e.g., video content captured by a user's client device 110) may be overlaid, one or more effects that users participating in the video exchange session may include in video content from the users, or other content for display or presentation to users participating in the video exchange session.

When the requesting user and at least one other user join the video exchange session, the video messaging module 235 generates an interface that is displayed to the requesting user and to other users who have joined the video exchange session. In various embodiments, the video messaging module 235 partitions the interface into regions, with each region corresponding to a user who has joined the video exchange session. The video messaging module 235 receives video content from a client device 110 of a user who has joined the video exchange session and displays the received video in a region of the interface corresponding to the user who has joined the video exchange session. The interface is transmitted to client devices 110 of users who have joined the video exchange session. Hence, the interface transmitted to a client device 110 of a user who has joined the video exchange session includes regions displaying video content from client devices 110 of other users who have joined the video exchange session, allowing for synchronous, or near-synchronous, exchange of video content between the users who have joined the video exchange session. In some embodiments, the interface includes a region showing video content from a user 110 who is viewing the interface, allowing the user to see the video from the user via the interface along with video content from other users who have joined the video exchange session. Alternatively, the interface does not include a region showing video content from the user who is viewing the interface, so the interface does not display video from the user who is viewing the interface, instead showing video content from other users who have joined the video exchange session to the user, with the user unable to view video content provided by the user to the video messaging module 235 via the interface shown to the user. In various embodiments,

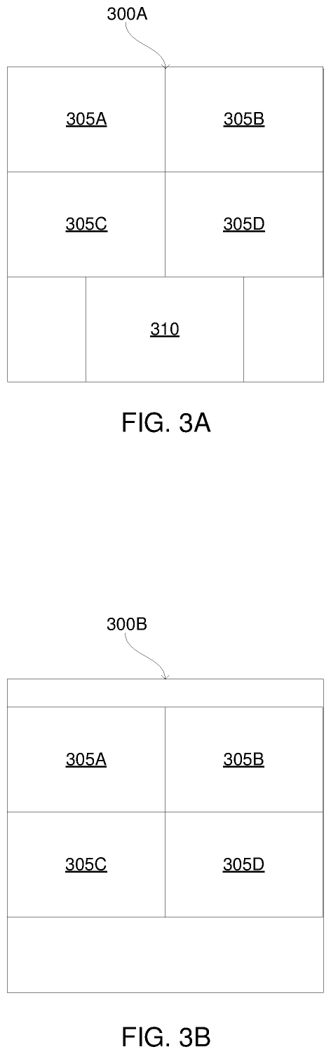

FIGS. 3A and 3B show example interfaces generated by the video messaging module 235 and displayed to users who have joined a video exchange session. For purposes of illustration, FIGS. 3A and 3B show interfaces presented to a viewing user 310 via a client device 110 of the viewing user. In the example shown by FIG. 3A, interface 300A includes regions 305A, 305B, 305C, 305D that each correspond to other users who have joined the video exchange session. Region 305A displays video content that the video messaging module 235 receives from a client device 110 of a first user, while region 305B displays video content that the video messaging module 235 receives from a client device 110 of a second user. Similarly, region 305C displays video content the video messaging module 235 receives from a client device 110 of a third user, and region 305D displays video content the video messaging module 235 receives from a client device 110 of a fourth user. Interface 300A also includes local region 310 that displays video content captured by the client device 110 of the viewing user and transmitted to the video messaging module 235, allowing the viewing user to view the video content that the client device 110 of the viewing user is transmitting to the video messaging module 235 via interface 300A. In contrast, FIG. 3B shows interface 300B, which includes regions 305A, 305B, 305C, 305D but does not include local region 310. Hence, interface 300B allows the viewing user to view video content that the video messaging module 235 receives from other users corresponding to regions 305A, 305B, 305C, 305D, but does not display video content captured by the client device 110 of the viewing user and transmitted to the video messaging module 235. In some embodiments, the viewing user may alter inclusion of local region 310 in interface 300A by modifying a setting maintained by the online system 140 for the user or maintained by an application executing on the client device 110 of the viewing user that displays interface 300A; hence, the viewing user may select display of interface 300A or interface 300B via the viewing user's client device 110 through one or more settings maintained for the viewing user by an application on the viewing user's client device 110 of by the online system 140.

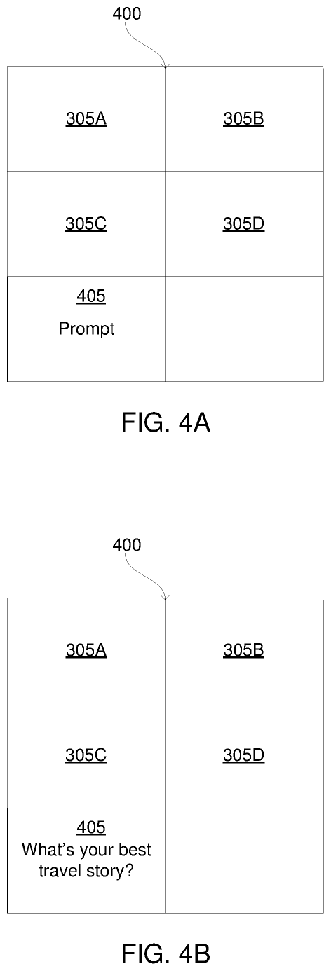

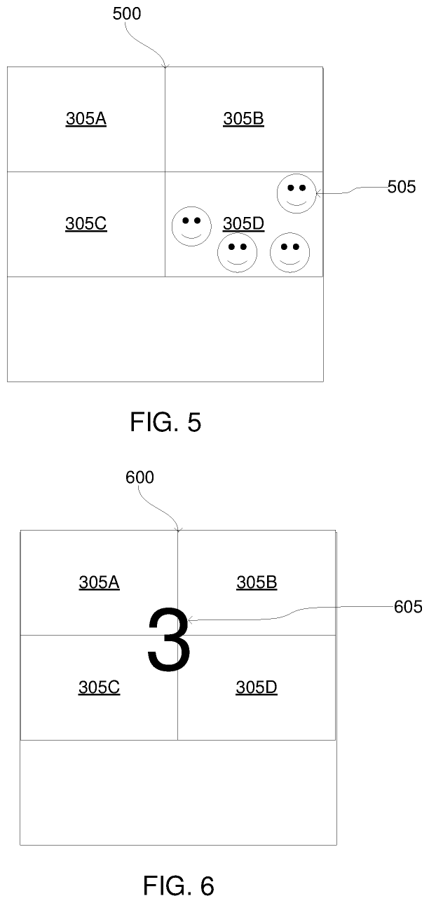

Referring back to FIG. 2, the video messaging module 235 modifies an interface generated for displaying video content received from users participating in a video exchange session based on inputs received from a user participating in the video exchange session. In one embodiment, the video messaging module 235 displays a prompt to users participating in the video exchange session that, when selected by a user participating in the video exchange session displays a question or a statement to users participating in the video exchange session via the interface to encourage interactions between the users participating in the video exchange session, as further described below in conjunction with FIGS. 4A and 4B. In other embodiments, the video messaging module 235 modifies video data received from a user participating in a video exchange session by overlaying images or text on video data received from the user participating in the video exchange session and displays the modified video data to other users via the interface, as further described below in conjunction with FIG. 5. Additionally, the video messaging module 235 may display instructions or countdown information to users participating in the video exchange session via the interface in response to receiving an input from a user participating in the video exchange session notifying users participating in the video exchange session that a user has requested to capture an image of the interface, as further described below in conjunction with FIGS. 6.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, or BlackberryOS.

### Displaying a Prompt for User Interaction to Users Participating in a Video Exchange Session

FIGS. 4A and 4B show an example interface 400 displaying a prompt of a topic for users participating in a video exchange session to address. In the example shown by FIG. 4A the interface 400 includes regions 305A, 305B, 305C, 305D that each correspond to other users who have joined the video exchange session. Video content received from a user participating in the video exchange session is displayed in a region 305A, 305B, 305C, 305D associated with the user, so a user viewing the interface 400 is displayed with video content received from users participating in the video exchange session.

Additionally, the interface 400 includes a prompt region 405. In various embodiments, the prompt region 405 displays image, text, or video data describing content subsequently displayed in the prompt region 405. For example, the prompt region 405 displays text indicating that a discussion topic or an ice breaker topic is subsequently displayed by the prompt region 405. In response to a user participating in the video exchange session interacting with the prompt region 405, the content displayed by the prompt region 405 is modified by the online system 140 to display a topic or a question to users participating in the video exchange session, as shown in FIG. 4B. This allows a user participating in the video exchange session to select or otherwise access the prompt region 405 to display a suggestion for a topic to be discussed by users participating in the video exchange session. In various embodiments, when the prompt region 405 displays a topic or a question, interaction with the prompt region 405 by a user participating in the video exchange session causes the online system 140 to display an alternative topic or question in the prompt region 405. For example, the prompt region 405 includes an input for changing or for refreshing a displayed topic or question in conjunction with the topic or the question. The online system 140 may maintain a store of topics or questions for display in the prompt region and selects an alternative stored topic or question when a user participating in the video exchange session selects the prompt region 405 while a topic or a question is displayed. In some embodiments, the online system 140 stores different topics or questions for display in association with different activities, allowing an activity specified for the video exchange session to determine topics or questions displayed by the prompt region 405.

### Displaying Content Overlaid on Video Content Received from a User

FIG. 5 is an example interface 500 where a region of the interface displaying video content from a user displays a graphic indication in response to an input from the user. In the example shown by FIG. 5 the interface 500 includes regions 305A, 305B, 305C, 305D that each correspond to other users who have joined the video exchange session. Video content received from a user participating in the video exchange session is displayed in a region 305A, 305B, 305C, 305D (also referred to individually or collectively using reference number 305) associated with the user, so a user viewing the interface 500 is displayed with video content received from users participating in the video exchange session.

When the online system 140 receives a specific input from a user participating in the video exchange session, the online system 140 modifies video content received from the user by overlaying content 505 on the video content received from the user. The online system 140 associates different specific inputs with different overlaying content 505 in various embodiments, allowing the online system 140 to display different overlaying content 505 on video content received from the user based on which specific input is received from the user. For example, different images that are each associated with different overlaying content 505 are displayed to the user, with the online system 140 displaying overlaying content 505 on video content received from a user corresponding to an image selected by the user. In the example of FIG. 5, the interface 500 displays the modified video content with the overlaying content 505 overlaid on the video content received from a user associated with region 305D. In various embodiments, the overlaying content 505 is displayed for a predetermined time interval, so the interface 500 displays unmodified video content from the user after the predetermined time interval lapses. The overlaying content 505 may be animated to move within the region associated 305 with the user from whom the online system received the specific input. Regions 305 of the interface 500 associated with other users continue to display video content received from the other users without modification in various embodiments.

### Notifying Users Participating in a Video Exchange Session of a Screen Capture

FIG. 6 is an example interface 600 displaying a countdown to users participating in a video exchange session for a screen capture of the video exchange session, in accordance with an embodiment. In the example shown by FIG. 6 the interface 600 includes regions 305A, 305B, 305C, 305D that each correspond to other users who have joined the video exchange session. Video content received from a user participating in the video exchange session is displayed in a region 305A, 305B, 305C, 305D (also referred to individually or collectively using reference number 305) associated with the user, so a user viewing the interface 600 is displayed with video content received from users participating in the video exchange session.

A user participating in the video exchange session may obtain a screen capture of the interface 600 displayed to the user via a client device 110 so the user may store the screen capture to view after the video exchange session has ended or to share with other users. Conventionally, when a user performs a screen capture of the interface 600, other users participating in the video exchange session are unaware of the screen capture by the user, preventing the other users from preparing for the screen capture. To notify other users participating in the video exchange session that a user is obtaining a screen capture of the interface 600, the online system 140 receives a request for a screen capture from a client device 110 of a user participating in the video exchange session. In response to receiving the request, the online system 140 displays a notification 605 to the users participating in the video exchange session via the interface 600. In various embodiments, the notification 605 is a countdown timer updating users participating in the video exchange session of an amount of time until the interface 600 is captured. Alternatively, the notification 605 is a text message or an image indicating to the users participating in the video exchange session that the interface 600 will be captured. The notification 605 may be superimposed across multiple regions 305 of the interface, as shown in FIG. 6, in various embodiments. After displaying the notification 605, the online system 140 captures an image of the interface 600 including content displayed by the regions 305 when the image is captured and transmits the captured image to the user who requested the screen capture. The user requesting the screen capture may subsequently share the captured image of the interface 600 with other users or share the captured image of the interface 600 through another application. In some embodiments, the online system 140 transmits a link to join the video exchange session to the user who requested the screen capture along with the captured image of the interface 600, allowing the user to share a link to join the video exchange session along with the captured image of the interface 600. The online system 140 may also store the captured image of the interface 600 in association with the video exchange session or in association with the user who requested the screen capture in some embodiments.

The online system 140 may overlay an animation, text, or an image on the interface 600 when capturing the image of the interface 600. The displayed animation, text, or image is included in the captured image of the interface 600 in various embodiments. The request from the user for the screen capture may specify the animation, text, or image displayed on the interface 600. Alternatively, an activity specified for the video exchange session specifies the animation, text, or image displayed on the interface 600 when the image is captured. The user requesting the screen capture may specify whether the animation, text, or image is displayed via the interface 600 when the image of the interface 600 is captured in various embodiments.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a creation request for establishing a video exchange session from a requesting user at an online system, the creation request identifying one or more other users to exchange video content with the requesting user;
generating, by the online system, an interface of the video exchange session, the interface including regions associated with each user participating in the video exchange session, a region associated with a user displaying video content the online system receives from the user;
receiving a specific input from a requesting user participating in the video exchange session at the online system;
modifying video content the online system received from the requesting user participating in the video exchange session so overlay content corresponding to the specific input is displayed over video content the online system receives from the user participating in the video exchange session; and
transmitting the interface from the online system including the modified video content the online system received from the user participating in the video exchange session in a region of the interface associated with the requesting user to client devices of one or more users participating in the video exchange session.

2. The method of claim 1, wherein different specific inputs are associated with different overlay content.

3. The method of claim 2, wherein different images are associated with different specific inputs.

4. The method of claim 2, wherein the interface displays different images corresponding to different specific inputs.

5. The method of claim 4, wherein receiving the specific input from the requesting user participating in the video exchange session at the online system comprises:
receiving, at the online system, a selection of a displayed image corresponding to the specific input from the receiving user.

6. The method of claim 5, wherein modifying video content the online system received from the requesting user participating in the video exchange session so overlay content corresponding to the specific input is displayed over video content the online system receives from the user participating in the video exchange session comprises:
modifying video content the online system received from the requesting user so an image corresponding to the selected displayed image is displayed over the video content the online system receives from the user participating in the video exchange session.

7. The method of claim 1, wherein modifying video content the online system received from the requesting user participating in the video exchange session so overlay content corresponding to the specific input is displayed over video content the online system receives from the user participating in the video exchange session comprises:
displaying the overlay content corresponding to the specific input over video content the online system receives from the user participating in the video exchange session for a predetermined time interval.

8. The method of claim 7, wherein modifying video content the online system received from the requesting user participating in the video exchange session so overlay content corresponding to the specific input is displayed over video content the online system receives from the user participating in the video exchange session further comprises:
displaying unmodified video content received from the user participating in the video exchange session after the predetermined time interval lapses.

9. The method of claim 1, wherein transmitting the interface from the online system including the modified video content the online system received from the user participating in the video exchange session in a region of the interface associated with the requesting user to client devices of one or more users participating in the video exchange session comprises:
transmitting the interface with the overlay content configured to move within the region of the interface associated with the requesting user and with video content received from other users displayed without modification.

10. A method comprising:
receiving a creation request for establishing a video exchange session from a user at an online system, the creation request identifying one or more other users to exchange video content with the requesting user;
generating, by the online system, an interface of the video exchange session, the interface including a prompt region displaying content to the users participating in the video exchange session and regions associated with each user participating in the video exchange session, a region associated with a user displaying video content the online system receives from the user;
receiving an interaction with the prompt region from a user participating in the video exchange session at the online system;
modifying content displayed in the prompt region to alternative content in response to receiving the interaction; and
transmitting the interface from the online system including the alternative content displayed in the prompt region to client devices of one or more users participating in the video exchange session.

11. The method of claim 10, wherein the content displayed in the prompt region is a topic and the alternative content is an alternative topic.

12. The method of claim 1, wherein the content displayed in the prompt region is associated with an activity selected for the video exchange session.

13. The method of claim 12, wherein the alternative content displayed in the prompt region is associated with the activity selected for the video exchange session.

14. A method comprising:
receiving a creation request for establishing a video exchange session from a requesting user at an online system, the creation request identifying one or more other users to exchange video content with the requesting user;
generating, by the online system, an interface of the video exchange session, the interface including regions associated with each user participating in the video exchange session, a region associated with a user displaying video content the online system receives from the user;
transmitting the interface from the online system to client devices of one or more users participating in the video exchange session;
receiving, at the online system, a request for a screen capture of the interface displayed on a client device of a requesting user from the client device;
transmitting a notification to client devices of the users participating in the video exchange session in response to receiving the request;
capturing, by the online system after the client devices of the users participating in the video exchange session display the notification, an image of the interface including content displayed by the regions of the interface when the image is captured; and
transmitting the image of the interface from the online system to the client device of the requesting user.

15. The method of claim 14, wherein the notification is a countdown timer updating the users participating in the video exchange session of an amount of time until the image of the interface is captured.

16. The method of claim 14, wherein the notification is superimposed across multiple regions of the interface.

17. The method of claim 14, wherein transmitting the image of the interface from the online system to the client device of the requesting user comprises:
transmitting a link to join the video exchange session from the online system to the client device of the requesting user along with the image of the interface.

18. The method of claim 14, wherein capturing, by the online system after the client devices of the users participating in the video exchange session display the notification, the image of the interface including content displayed by the regions of the interface when the image is captured comprises:
overlaying content on the interface when capturing the image of the interface; and
capturing an image of the interface with the overlaid content included in the image of the interface including content displayed by the regions of the interface when the image is captured.

19. The method of claim 18, wherein the request from the requesting user specifies the overlaid content.

20. The method of claim 18, wherein the overlaid content is specified by an activity associated with the video exchange session.
